(19) United States
(12) Patent Application Publication
(10) Pub. No.: US 2022/0172263 A1
(43) Pub. Date: Jun. 2, 2022

(54) INFORMATION PROCESSING SYSTEM, METHOD OF INFORMATION PROCESSING, AND PROGRAM

(71) Applicant: TOYOTA JIDOSHA KABUSHIKI KAISHA, Toyota-shi Aichi-ken (JP)

(72) Inventors: Takaaki Yanagihashi, Toyota-shi Aichi-ken (JP); Takahiro Okano, Chiryu-shi Aichi-ken (JP); Toru Takashima, Susono-shi Shizuoka-ken (JP); Hiroaki Kiyokami, Nisshin-shi Aichi-ken (JP); Kenta Miyahara, Okazaki-shi Aichi-ken (JP); Yohei Tanigawa, Toyota-shi Aichi-ken (JP)

(73) Assignee: TOYOTA JIDOSHA KABUSHIKI KAISHA, Toyota-shi Aichi-ken (JP)

(21) Appl. No.: 17/512,026

(22) Filed: Oct. 27, 2021

(30) Foreign Application Priority Data
Nov. 30, 2020 (JP) 2020-199113

(51) Int. Cl. G06Q 30/06; G06Q 20/20; G06Q 10/08; G06Q 10/06

(52) U.S. Cl. CPC G06Q 30/0605; G06Q 30/0633; G06Q 30/0623; G06Q 20/3276; G06Q 20/209; G06Q 10/0834; G06Q 10/06315; G06Q 20/202

(57) ABSTRACT

An information processing system includes an information processing device. The information processing device receives identification information that identifies prescribed commodities that a user desires to purchase at a plurality affiliated stores, and specifies a commodity group that the user desires to purchase based on the identification information. When receiving indication information to indicate settlement of the commodity group, the information processing device is configured to execute settlement processing for the specified commodity group.

### CROSS-REFERENCE TO RELATED APPLICATION

This application claims priority to Japanese Patent Application No. 2020-199113 filed on Nov. 30, 2020, incorporated herein by reference in its entirety.

### BACKGROUND

### 1. Technical Field

The present disclosure relates to an information processing system, a method of information processing, and a program.

### 2. Description of Related Art

Japanese Unexamined Patent Application Publication No. 2019-179425 (JP 2019-179425 A) discloses a system that allows a user who shops at a prescribed store to photographs a QR code (registered trademark) provided on a commodity to acquire purchase object information from the QR code (registered trademark), transmit user information, the purchase object information, and settlement information to a server, and perform, under the control of the server, settlement of the commodity in a settlement server.

### SUMMARY

Incidentally, in JP 2019-179425 A, consideration is not given to the case where a user desires to purchase commodities from a plurality of stores. Therefore, with the technology of JP 2019-179425 A, when a user desires to purchase commodities from a plurality of stores, settlement processing is repeated for each store where purchase is made. This complicates the procedures required for commodity purchase.

The present disclosure has been made in consideration of the above issue, and it is an object of the present disclosure to provide an information processing system, a method of information processing, and a program, capable of simplifying the procedures required for commodity purchase when a user desires to purchase commodities from a plurality of stores.

An information processing system according to a first aspect includes an information processing device. The information processing device includes an identification information reception unit configured to receive identification information that identifies prescribed commodities that a user desires to purchase at a plurality of affiliated stores, a specification unit configured to specify, based on the received identification information, a commodity group that the user desires to purchase, an indication information reception unit configured to receive indication information to indicate settlement of the commodity group, and a settlement processing execution unit configured to execute, when the indication information is received, settlement processing for the commodity group.

The information processing system according to the first aspect includes an information processing device. The information processing device receives identification information that identifies prescribed commodities that the user desires to purchase at a plurality affiliated stores, and specifies a commodity group that the user desires to purchase. When receiving indication information to indicate settlement of the commodity group, the information processing device executes settlement processing for the specified commodity group. Accordingly, when the user desires to purchase commodities from a plurality of stores, it is not necessary to perform settlement processing for each store where purchase is made. This makes it possible to simplify the procedures required for commodity purchase when a user desires to purchase commodities from a plurality of stores.

The information processing system according to a second aspect has the configuration in the first aspect. In the configuration, the information processing device further includes a category setting unit configured to set a category to the commodities based on the identification information. The specification unit specifies the commodity in each set category.

According to the information processing system in the second aspect, the user can set a category for the commodities that the user desires to purchase, and make settlement of a commodity group in each category. Hence, it becomes possible to set a category for each commodity in terms of, for example, a commodity type, a desired delivery condition, the degree of desire for purchase, and the like, and to make settlement of the commodity group in each category at optimum time.

The information processing system according to a third aspect has the configuration in the second aspect. In the configuration, the category is a commodity type category.

The information processing system according to the third aspect allows the user to set a category that is categorized by commodity type to the commodities that the user desires to purchase. Therefore, when, for example, a commodity group that the user desires to purchase includes a mixture of perishable foods and clothes, it is possible to set different categories to these commodities, and make settlement separately.

The information processing system according to a fourth aspect has the configuration in the second aspect. In the configuration, the category is a delivery condition category.

The information processing system according to the fourth aspect allows the user to set a category that is categorized by the delivery condition to the commodities that the user desires to purchase. Therefore, when, for example, a commodity group that the user desires to purchase includes a commodity that the user desires its delivery on the same day and other commodities, it is possible to set different categories to these commodities, and make settlement of a commodity group that the user desires its delivery on the same day first.

The information processing system according to a fifth aspect has the configuration in any one of the first to fourth aspects. In the configuration, the information processing device further includes an information generation unit configured to generate display information to display to the user the specified commodity group as a commodity group scheduled to be settled. The display information includes a cancellation indication object to indicate cancellation of settling the respective commodities that constitute the commodity group.

According to the information processing system in the fifth aspect, the information processing device generates display information to display to the user the specified commodity group as a commodity group scheduled to be settled. The display information includes a cancellation indication object to indicate cancellation of the settlement for the respective commodities that constitute the commodity group. Therefore, after the user desires to purchase commodities, the user can cancel purchase of the commodities displayed as a commodity group scheduled to be settled as necessary. This allows the user an opportunity to consider the purchase of the commodities after the user desires to purchase them.

The information processing system according to a sixth aspect has the configuration in any one of the first to fifth aspects. In the configuration, the information processing device further includes a purchase information notification unit. The purchase information notification unit is configured to generate, for the commodity group after execution of the settlement processing, purchase information about the respective commodities that constitute the commodity group, and notify the purchase information to store terminals of the affiliated stores that are vendors of the commodities.

In the information processing system according to the sixth aspect, for the commodity group after execution of the settlement processing, purchase information about the respective commodities that constitute the commodity group is generated, and the purchase information is notified to the store terminals of the affiliated stores that are vendors of the commodities. This makes it possible to promptly notify a purchase status of the commodities of the stores to the store side, and reflect the purchase status on stock information and customer information.

The information processing system according to a seventh aspect has the configuration in any one of the first to sixth aspects. In the configuration, the information processing device further includes a delivery request processing unit. The delivery request processing unit is configured to generate, for the commodity group after execution of the settlement processing, request information to request delivery in units of the commodity group, and notify the request information to a delivery terminal of a delivery company.

In the information processing system according to the seventh aspect, it is possible to request delivery of the commodity group after execution of the settlement processing in units of commodity groups, to the delivery company. This allows the user to purchase the commodities that the user sees in the stores and go home empty-handed, so that a load of the user related to shopping can be reduced. Furthermore, since it is possible to collectively deliver the commodities purchased in a plurality of stores in units of commodity groups, the procedures for the user to receive the commodities can be simplified.

A method of information processing according to an eighth aspect includes: receiving identification information that identifies prescribed commodities that a user desires to purchase at a plurality of affiliated stores; specifying, based on the received identification information, a commodity group that the user desires to purchase; receiving indication information to indicate settlement of the commodity group; and executing, when the indication information is received, settlement processing for the commodity group.

The method of information processing according to the eighth aspect can simplify the procedures required for commodity purchase when a user desires to purchase commodities from a plurality of stores.

A program according to a ninth aspect causes a computer to execute: receiving identification information that identifies prescribed commodities that a user desires to purchase at a plurality of affiliated stores; specifying, based on the received identification information, a commodity group that the user desires to purchase; receiving indication information to indicate settlement of the commodity group; and executing, when the indication information is received, settlement processing for the commodity group.

The method of information processing according to the ninth aspect can simplify the procedures required for commodity purchase when a user desires to purchase commodities from a plurality of stores.

The present disclosure can simplify the procedures required for commodity purchase when a user desires to purchase commodities from a plurality of stores.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the schematic configuration of an information processing system according to an embodiment;

FIG. 2 is a block diagram showing the hardware configuration of an information processing device 20 according to the embodiment;

FIG. 3 is a block diagram showing the functional configuration of the information processing device 20 according to the embodiment;

FIG. 4 is a block diagram showing the hardware configuration of an information processing device 30 according to the embodiment;

FIG. 5 is a block diagram showing the functional configuration of the information processing device 30 according to the embodiment;

FIG. 6A is a schematic diagram showing an example of a service of the information processing system;

FIG. 6B is a schematic diagram showing the example of a service of the information processing system;

FIG. 7 is an activity diagram showing an operation flow of the information processing device 20;

FIG. 8A shows an example of a display screen displayed on the information processing device 30;

FIG. 8B shows another example of the display screen displayed on the information processing device 30;

FIG. 9A shows an example of a display screen displayed on the information processing device 30;

FIG. 9B shows another examples of the display screen displayed on the information processing device 30; and

FIG. 10 is a block diagram showing the functional configuration of an information processing device 60 according to an embodiment.

### DETAILED DESCRIPTION OF EMBODIMENTS

### First Embodiment

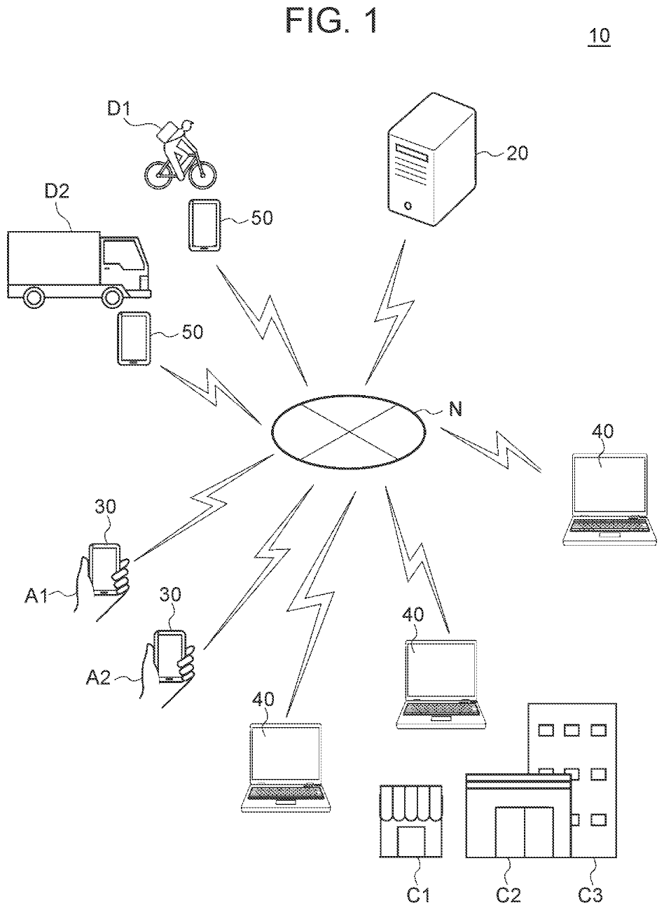

With reference to the drawings, an information processing system 10 as an embodiment of the present disclosure will be described below. FIG. 1 shows the schematic configuration of the information processing system 10 according to a first embodiment. The information processing system 10 includes an information processing device 20, information processing devices 30, store terminals 40, and delivery terminals 50. The information processing device 20, the information processing devices 30, the store terminals 40, and the delivery terminals 50 are configured so as to be able to communicate with each other via a network N.

In an example, the information processing device 20 operates as a server.

The information processing devices 30 are terminals, such as smartphones or personal computers, used by users A (A1, A2) who shop using the information processing system 10. The store terminals 40 are terminals, such as smartphones and personal computers, installed at affiliated stores C (C1-C3), such as actual stores or internet shops that sell commodities using the information processing system 10. The delivery terminals 50 are terminals, such as smartphones and personal computers, used by delivery companies D (D1, D2) that contract delivery of the commodities purchased by the users A.

The information processing system 10 provides a service to assist shopping of the users A. Specifically, the information processing system 10 provides the service that enables collective settlement of the commodities that a user A desire to purchase at affiliated stores C1 to C3 and allows delivery of the commodities in units of purchased commodity groups.

### Hardware Configuration of Information Processing Device 20

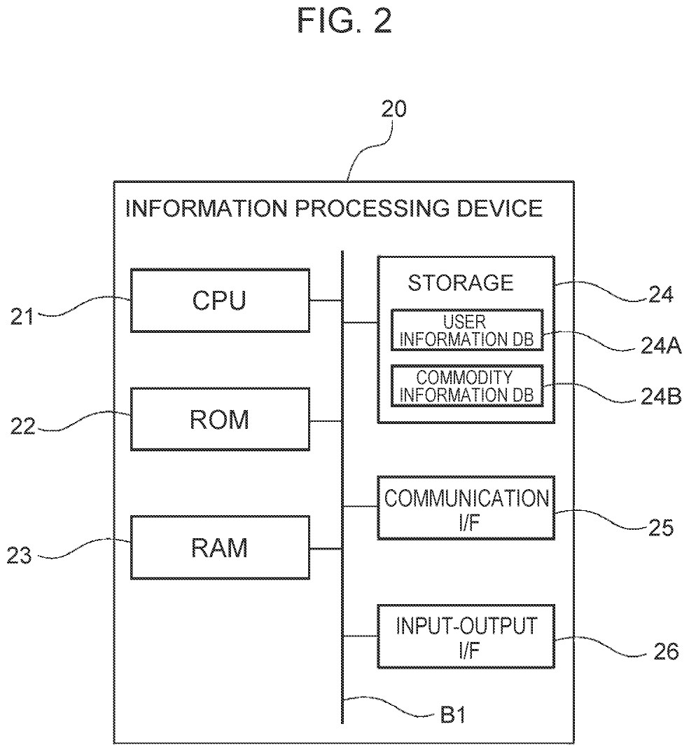

FIG. 2 is a block diagram showing the hardware configuration of the information processing device 20. The information processing device 20 is configured to include a central processing unit (CPU) 21, a read only memory (ROM) 22, a random access memory (RAM) 23, a storage 24, a communication interface (I/F) 25, and an input-output interface 26. The CPU 21, the ROM 22, the RAM 23, the storage 24, the communication interface 25, and the input-output interface 26 are communicably connected with each other through a bus B1.

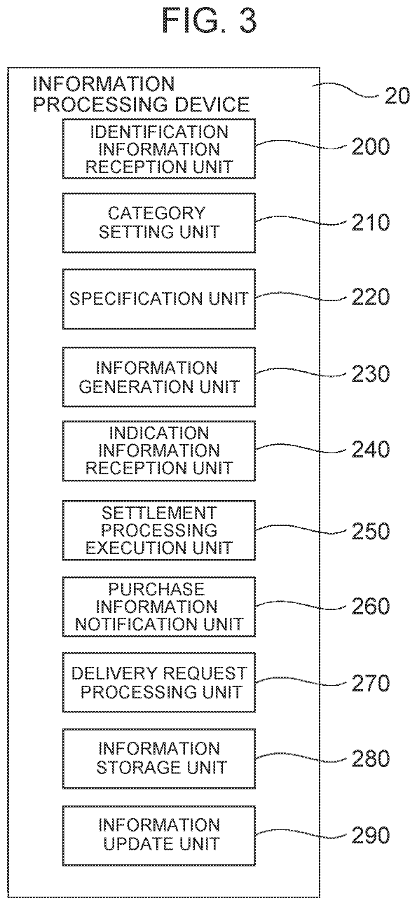

The CPU 21 is a central processing unit that executes various programs, and controls each unit. More specifically, the CPU 21 reads programs from the ROM 22 or the storage 24, executes the programs by using the RAM 23 as a work area. In the present embodiment, the ROM 22 or the storage 24 stores execution programs. The CPU 21 reads the execution programs stored in the ROM 22 and executes the execution programs to implement the functions of the units shown in FIG. 3. The units include an identification information reception unit 200, a category setting unit 210, a specification unit 220, an information generation unit 230, an indication information reception unit 240, a settlement processing execution unit 250, a purchase information notification unit 260, a delivery request processing unit 270, an information storage unit 280, and an information update unit 290.

The ROM 22 stores various programs and various data. As a work area, the RAM 23 temporarily stores programs or data. The storage 24 is constituted of a storage device, such as a hard disk drive (HDD) or a solid state drive (SSD), and stores various programs and various data including an operating system. In the present embodiment, a user information database (DB) 24A and a commodity information database 24B are stored in the storage 24. The storage unit such as the storage 24 can be provided in another device that can communicate with the information processing device 20.

The communication interface 25 as a communicating unit is an interface for communicating with the information processing devices 30, the store terminals 40, the delivery terminals 50, and the like. For example, the communication interface 25 adopts standards such as Ethernet (registered trademark), FDDI, and Wi-Fi (registered trademarks) standards.

The input-output interface 26 is an interface for connecting the information processing device 20 to external devices. For example, the input-output interface 26 is a connection unit that conforms to the standards such as universal serial bus (USB), and high-definition multimedia interface (HDMI (registered trademark)). The input-output interface 26 allows connection of input devices such as keyboards and display devices such as monitors.

As the information processing device 20, computers for general-purpose servers, personal computers, etc. may be used. The information processing device 20 may also be configured using a plurality of computers.

### Functional Configuration of Information Processing Device 20

FIG. 3 is a block diagram showing an example of the functional configuration of the information processing device 20. The information processing device 20 includes the identification information reception unit 200, the category setting unit 210, the specification unit 220, the information generation unit 230, the indication information reception unit 240, the settlement processing execution unit 250, the purchase information notification unit 260, the delivery request processing unit 270, the information storage unit 280, and the information update unit 290.

The identification information reception unit 200 is configured to receive identification information that identifies prescribed commodities that a user A desires to purchase. The identification information is input from an input assist unit 310 of the information processing device 30. The identification information includes user identification information that identifies each of the users A who desire to purchase commodities, and commodity identification information that identifies prescribed commodities.

The category setting unit 210 is configured to set a category to the commodities that the user A desires to purchase based on the identification information received by the identification information reception unit 200.

The specification unit 220 specifies, based on the identification information received by the identification information reception unit 200, a commodity group that the user A desires to purchase. In this case, the specification unit 220 specifies commodities corresponding to the identification information of the same category, based on the identification information stored in the information storage unit 280 and the category information about the category set in each identification information.

The information generation unit 230 generates display information to display the commodity group identified in the specification unit 220 as a commodity group scheduled to be settled. The display information is displayed to the user A who desires to purchase the commodity group. The display information may include commodity information on the respective commodities that constitute the commodity group. For example, the commodity information relates to the name and quality of the pertinent commodities, the sales price of the commodities, and the name of the store that is the vendor of the commodities. The information generation unit 230 acquires the commodity information from the commodity information database 24B stored in the storage 24, based on the commodity identification information included in the received identification information. The display information may also include a cancellation indication object to indicate cancellation of the settlement (payment) for each of the commodities. The display information may also include a category change indication object to indicate change of the category set for each commodity.

In addition, the information generated by the information generation unit 230 may include a start indication object to start an application software used when the user A desires to purchase the pertinent commodity and performs settlement of the commodity, a purchase desire indication object to indicate the desire of purchase of the commodity, and a category indication object to indicate setting a category to the commodity. When the application software corresponding to the information processing device 30 is not yet installed, installation of the corresponding application software may be encouraged, or a web browser may be started with the address of the corresponding website as an argument.

The indication information reception unit 240 is configured to receive indication information to indicate settlement of the commodity group specified in the specification unit 220. The identification information is input from the input assist unit 310 of the information processing device 30.

The settlement processing execution unit 250 executes, when the indication information is received in the indication information reception unit 240, settlement processing for the commodity group indicated to be settled. At the time, the settlement processing execution unit 250 acquires user information from the user information database 24A based on the user identification information included in the identification information. The user information includes various information necessary for settlement, including, for example, credit card number, and the personal name of the user A. The settlement processing execution unit 250 also acquires the commodity information on the commodities to be settled, based on the commodity information included in the identification information. The settlement processing execution unit 250 executes settlement processing for the commodity group based on the acquired user information and commodity information. Note that actual settlement processing may be configured to be performed by external devices configured to be communicable via the communication interface 25. For example, the external devices may be servers managed by credit companies or the like. Specifically, the settlement processing execution unit 250 may transmit to an external device the information including the acquired user information and commodity information managed in association with each other, and perform the settlement processing in the external device.

The purchase information notification unit 260 generates, for the commodity groups after execution of the settlement processing executed by the settlement processing execution unit 250, purchase information about the respective commodities that constitute the commodity group. The purchase information notification unit 260 notifies the purchase information to the store terminals 40 of the affiliated stores C that are vendors of the commodities. The purchase information may include information about the type and quantity of the purchased commodities, and date and time of the purchase.

The delivery request processing unit 270 generates, for the commodity group after execution of the settlement processing, request information to request delivery in units of commodity groups. The delivery request processing unit 270 notifies the request information to the delivery terminal 50 of the delivery company D. The request information may include the personal name of the user A who has purchased the commodity group, the address of a delivery destination, and desired delivery date and time. The delivery request processing unit 270 may receive delivery contract information indicating that delivery contract is agreed from the delivery terminal 50. When receiving the delivery contract information, the delivery request processing unit 270 may notify request confirmation information to notify that the delivery request is confirmed to the delivery terminal and the information processing device 30 of the user A.

The information storage unit 280 stores the above-mentioned identification information, as well as various information such as the category information, the user information, and the purchase information in the storage 24.

The information update unit 290 updates the various information acquired and stored in the storage 24.

### Hardware Configuration of Information Processing Device 30

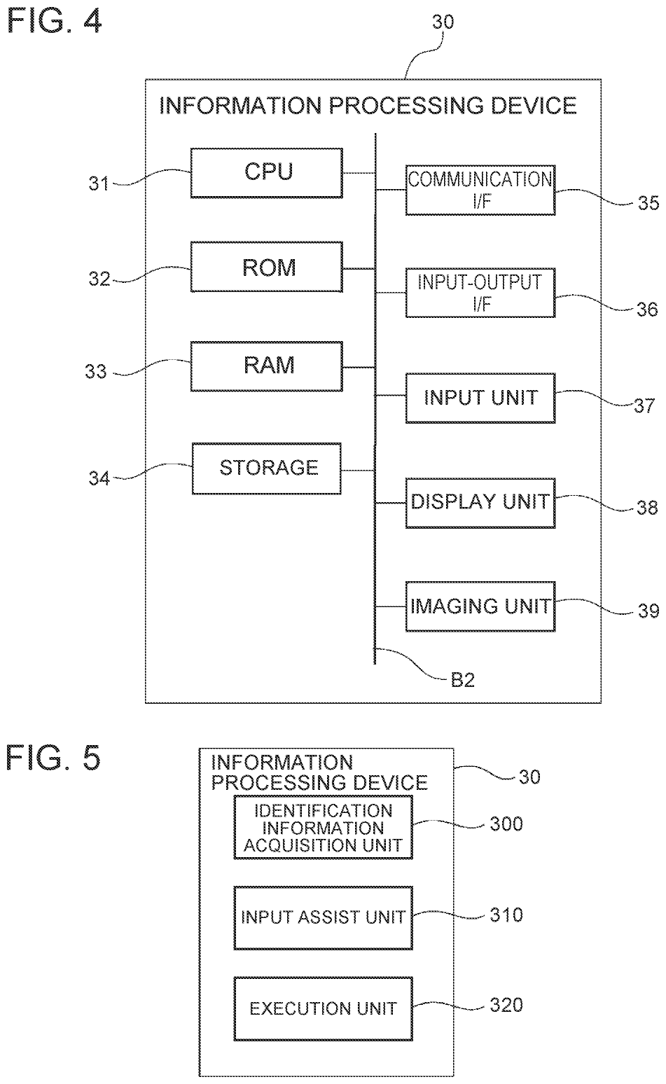

FIG. 4 is a block diagram showing the hardware configuration of the information processing device 30. The information processing device 30 is configured to include a CPU 31, a ROM 32, a RAM 33, a storage 34, a communication interface 35, an input-output interface 36, an input unit 37, a display unit 38, and an imaging unit 39. The CPU 31, the ROM 32, the RAM 33, the storage 34, the communication interface 35, the input-output interface 36, the input unit 37, the display unit 38, and the imaging unit 39 are communicably connected with each other via a bus B2.

The CPU 31 reads programs from the ROM 32 or the storage 34, executes the programs by using the RAM 33 as a work area. In the present embodiment, the ROM 32 stores execution programs. The CPU 31 reads and executes the execution programs stored in the ROM 32 to implement the functions of an identification information acquisition unit 300, an input assist unit 310 and an execution unit 320 shown in FIG. 5.

The ROM 32 stores various programs and various data. The RAM 23 functions as a work area to temporarily store programs or data. The storage 24 as a storage unit is constituted of a HDD or a SSD, and stores various programs and various data.

The communication interface 35 as a communicating unit is an interface for communicating with the information processing device 20, and other external devices. For example, the communication interface 35 adopts standards such as Ethernet (registered trademark), FDDI, and Wi-Fi (registered trademarks) standards.

The input-output interface 36 is an interface for connecting the information processing device 30 to external devices. For example, the input-output interface 36 is a connection unit that conforms to the standards such as a universal serial bus, and a high-definition multimedia interface. The input-output interface 36 allows connection of input devices such as keyboards and display devices such as monitors.

The input unit 37 receives operation input. The display unit 38 displays information or the like. The input unit 37 and the display unit 38 may be integrated as a touch panel.

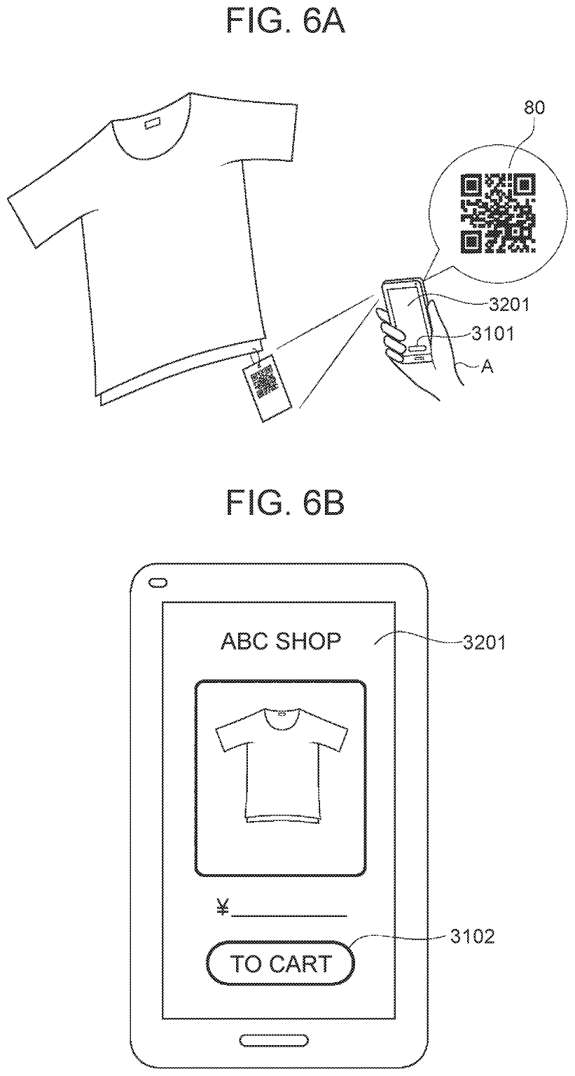

The imaging unit 39 is constituted of a camera or the like to image various images. In the present embodiment, the user A uses the imaging unit 39 to image an image including a commodity identification code 80 (see FIG. 6A).

### Functional Configuration of Information Processing Device 30

FIG. 5 is a block diagram showing an example of the functional configuration of the information processing device 30. As shown in FIG. 5, the information processing device 30 includes the identification information acquisition unit 300, the input assist unit 310, and the execution unit 320.

The identification information acquisition unit 300 is configured to receive identification information that identifies prescribed commodities that the user A desires to purchase. The identification information is acquired by reading the identification code 80 attached to the commodities as described later, and by selecting the purchase desire indication object from a browsing screen for browsing the commodities of the affiliated stores C when the application software described later is started. In other words, the identification information is acquired by the user A operating the information processing device 30.

For example, the input assist unit 310 is a software keyboard that inputs the operation (input information), performed by the user A to the various indication objects displayed at the start of the application, into the identification information reception unit 200 as the identification information. The identification information is input through the input assist unit 310 into the execution unit 320.

The functions of the execution unit 320 are implemented by application software executed in the information processing device 30. For example, the execution unit 320 has the functions for the user A to purchase commodities. The functions include a function to generate display screen for the user A to browse the commodities of the affiliated stores C, and a function to implement operation of various indication objects.

### Operation

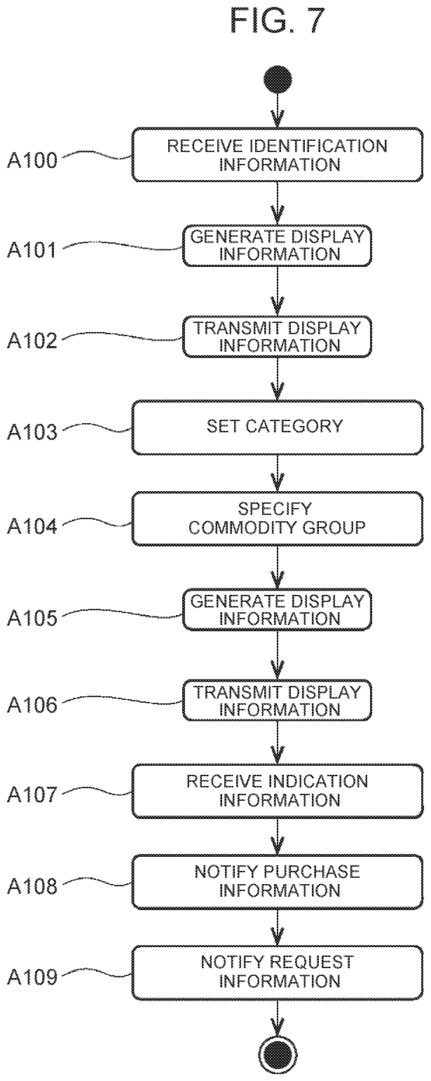

Next, with reference to FIG. 7, the operation of the information processing device 20 will be described. FIG. 7 is an activity diagram showing the flow of operation of the information processing device 20.

First, as a premise, a user A who operates the information processing device 30 starts the application software for purchasing commodities, and displays an application screen 3201 on the information processing device.

As shown in FIG. 6A, the application screen 3201 at the start of the application may display, for example, an imaging indication button 3101 as an imaging indication object to indicate imaging the commodity identification code 80 with the imaging unit 39. When the user A selects the imaging indication button 3101, the imaging unit 39 is started, and the function of the identification information acquisition unit 300 is executed.

When the user A images the identification code 80 of a commodity that the user A desires to purchase, the identification information acquisition unit 300 reads the identification code 80 from the imaged image to acquire the identification information of the commodity. The identification code 80 is coded information specific to the commodity, such as a bar code or a QR code (registered trademark).

Meanwhile, as shown in FIG. 6B, the application screen 3201 may display the commodity browsing pages of the affiliated stores C. On the application screen 3201, a purchase desire indication button 3102 may be displayed as a purchase desire indication object to indicate a desire to purchase the commodity. When the user A selects the purchase desire indication button 3102 on the browsing page of the commodity that the user A desires to purchase, the identification information for the commodity is generated. Then, the identification information acquisition unit 300 acquires the identification information.

In the above configuration, the application screen 3201 corresponds to the execution unit 320. The imaging indication button 3101 and the purchase desire indication button 3102 correspond to the input assist unit 310. When the identification information is acquired, the information is notified to the identification information reception unit 200 from the input assist unit 310.

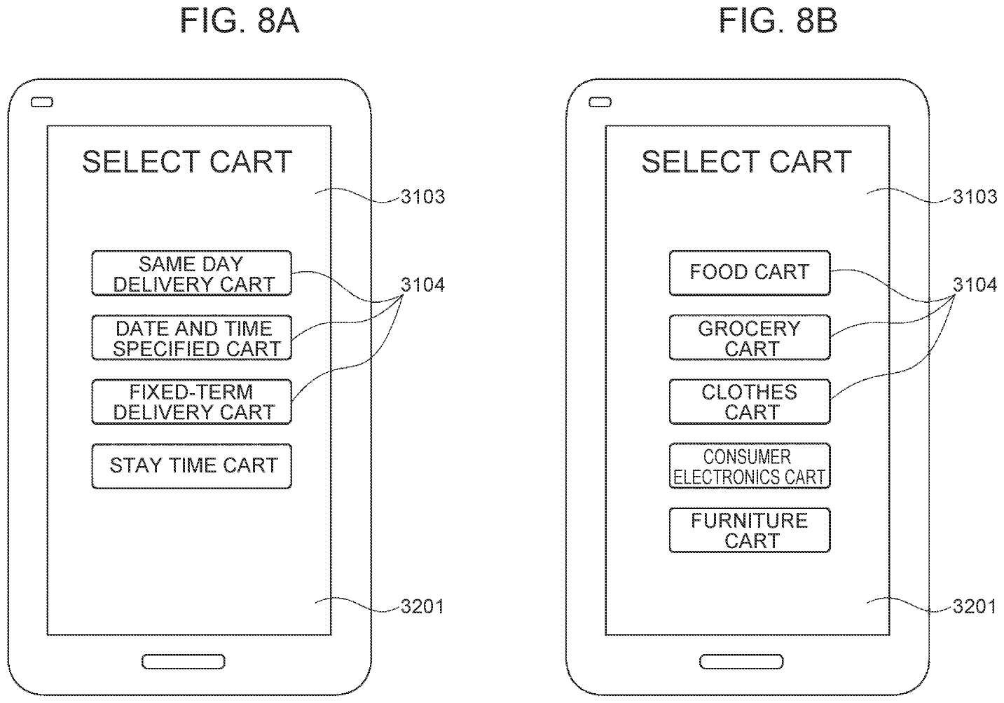

The CPU 21 of the information processing device 20 receives the identification information (A100). When the CPU 21 receives the identification information, the display information is generated with the function of the information generation unit 230 (A101). The CPU 21 then transmits the generated display information to the information processing device 30 (A102). Hence, as shown in FIGS. 8A and 8B as examples, the display screen of the information processing device 30 displays a setting screen for setting the category of the commodity.

As shown in FIG. 8A, the user A can set a delivery condition category to the commodities that the user A desires to purchase. As shown in FIG. 8A, on the application screen 3201 of the information processing device 30, a message 3103 requesting to set a category to each commodity, and a plurality of buttons 3104 indicating a plurality of categories are displayed. The buttons 3104 constitute category indication buttons 3104 as a category indication object indicating to set a category for each commodity. For example, selecting one of the category indication buttons 3104 enables the user A to set “same day delivery cart” category for requesting delivery of the commodity to a delivery destination on the same day. Selecting one of the category indication buttons 3104 enables the user A to set “date and time specified cart” category for requesting delivery at date and time that the user A desires. Selecting one of the category indication buttons 3104 enables the user A to set “fixed-term delivery cart” category for requesting fixed-term settlement and delivery of a commodity group that the user A desires to purchase at a prescribed time depending on the settings set by the user A. Selecting one of the category indication buttons 3104 enables the user A to set “stay time cart” category for requesting delivery during a time slot where the user A stays at the delivery destination. The user A can optionally set the time when the user A stays at the delivery destination in advance. The delivery condition categories described above are merely exemplary. The details of the delivery condition categories and the number of options can be changed as appropriate.

As shown in FIG. 8B, the user A can set a commodity type category to the commodities that the user A desires to purchase, for example. As shown in FIG. 8B, for example, selecting one of the category indication buttons 3104 enables the user A to set “food cart” category for setting that the commodity type is food. Selecting one of the category indication buttons 3104 enables the user A to set “grocery cart” category for setting that the commodity type is grocery. Selecting one of the category indication buttons 3104 enables the user A to set “clothes cart” category for setting that the commodity type is clothes. Selecting one of the category indication buttons 3104 enables the user A to set “consumer electronics cart” category for setting that the commodity type is consumer electronics. Selecting one of the category indication buttons 3104 enables the user A to set “furniture cart” category for setting that the commodity type is furniture. The commodity type categories described above are merely exemplary. The details of the commodity type categories and the number of options can be changed as appropriate. For example, a category indicating that the commodity is fragile, a category indicating that the commodity is raw or frozen foods, and a category that the commodity is a gift may be provided. Alternatively, it is also possible to enable the user A to set both the delivery condition category and the commodity type category.

When the user A selects any category indication button 3104 on the application screen 3201 on the information processing device 30, the input assist unit 310 notifies the input information to the information processing device 20. As a result, the CPU 21 sets a category to the commodity related to the identification information (A103).

Next, the CPU 21 specifies a commodity group set to the same category, among the commodities that the user A desires to purchase, with the function of the specification unit 220 (A104). When the commodity category is not set, the CPU 21 specifies a plurality of commodities that the user A desires to purchase as a product group, based on the identification information received with the function of the identification information reception unit 200.

Next, when the user A requests settlement of the commodities that the user A desires to purchase, the CPU 21 generates display information to display a commodity group specified with the function of the specification unit 220 as a commodity group scheduled to be settled (A105). When the display information is generated, the CPU 21 transmits the generated display information to the information processing device 30 (A106). For example, the display information is generated and transmitted when the user A operates, on the application screen 3201 of the information processing device 30, an indication object button indicating to display the commodities to which a prescribed category is set. The input information input into the indication object by the user A is notified to the information processing device 20 through the input assist unit 310. As a result, the display information is generated and transmitted.

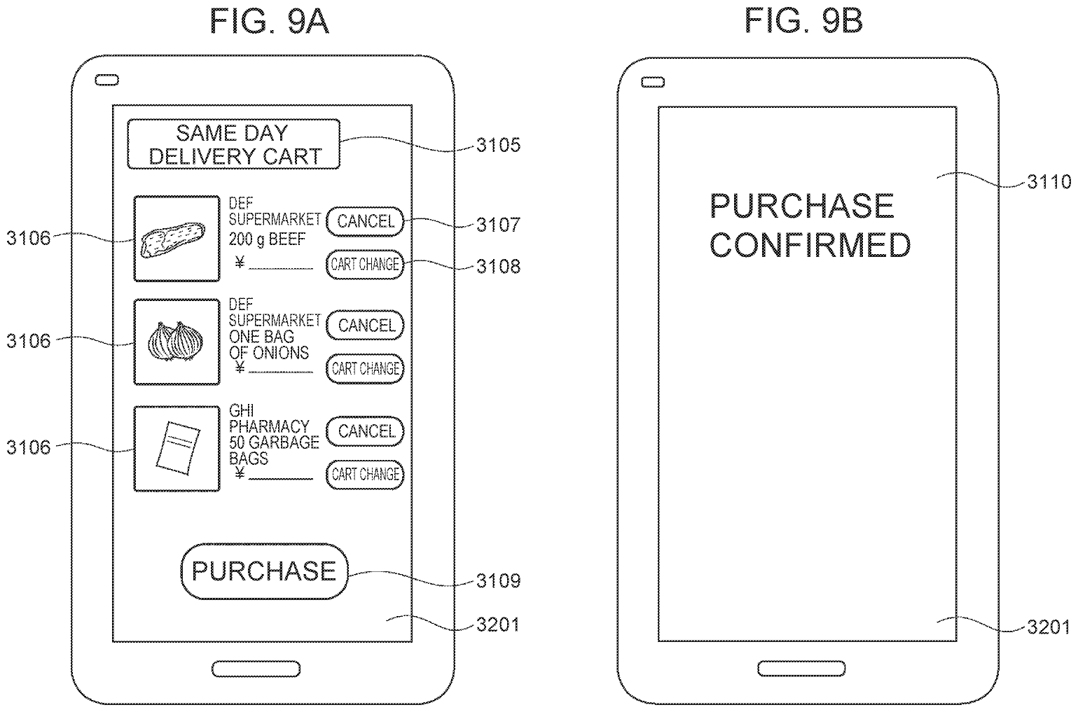

FIG. 9A shows an example of display information in which specified commodity group is displayed on the application screen 3201 as a commodity group scheduled to be settled. The application screen 3201 includes a category name 3105 representing a category that the user A indicates to display, and commodity information 3106 about the commodities of the same category. The displayed commodity information includes photographs of the commodities, the name of the commodities, the name of the affiliated stores C that are vendors, and sales prices or the like.

The application screen 3201 also includes, as the display information, a cancel button 3107 as a cancellation indication object to indicate cancellation of the settlement of the respective commodities. When the user A selects the cancel button 3107, the corresponding commodity can be removed from the commodity group scheduled to be settled.

The application screen 3201 also includes, as the display information, a category change button 3108 as a category change indication object to indicate change of the category set to the respective commodities. When the user A selects the category change button, the category setting screen shown in FIGS. 8A and 8B is displayed for the corresponding commodity, and the category set for each commodity can be changed.

The application screen 3201 also includes, as the display information, a settlement indication button 3109 as a settlement indication object to indicate settlement of the commodity group scheduled to be settled. When the user A selects the settlement indication button 3109, the input assist unit 310 notifies the indication information to indicate settlement of the commodity group to the information processing device 20.

Next, the CPU 21 receives the indication information notified from the input assist unit 310 by using the function of the indication information reception unit 240 (A107). The CPU 21 then executes settlement of the commodity group with the function of the settlement processing execution unit 250 (A108). Once the settlement processing is completed, the CPU 21 generates prescribed display information with the function of the information generation unit 230, and transmits the generated information to the information processing device 30. Hence, as shown in 9B as an example, the application screen 3201 of the information processing device 30 displays a message 3110 indicating that the settlement is completed.

Next, the CPU 21 generates purchase information about the respective commodities in the commodity group for which the settlement processing is executed, based on the function of the purchase information notification unit 260. The CPU 21 then notifies the purchase information on the respective commodities to the store terminals 40 of the affiliated stores C that are vendors of the commodities (A109).

Next, the CPU 21 generates, for the settled commodity group, request information to request delivery in units of the commodity groups based on the function of the delivery request processing unit 270. Then, the CPU 21 notifies the request information to the delivery terminal 50 of the delivery company D (A110).

In the information processing system 10 according to the first embodiment as described in the foregoing, the information processing device 20 receives identification information that identifies prescribed commodities that the user A desires to purchase at a plurality of the affiliated stores C1 to C3, and specifies a commodity group that the user A desires to purchase based on the identification information. When receiving indication information to indicate settlement of the commodity group, the information processing device 30 executes settlement processing for the specified commodity group. Accordingly, when the user A desires to purchase commodities from a plurality of stores, it is not necessary to perform settlement processing for each store where purchase is made. This makes it possible to simplify the procedures required for commodity purchase when a user desires to purchase commodities from a plurality of stores.

For example, as shown in FIG. 6A, when the user A reads the identification codes 80 displayed on the tags of exhibited commodities, or the like, the system can receive identification information on the commodities that the user A desires to purchase at a plurality of actual stores. Then, when the commodities that the user A desires to purchase are collectively settled, it is not necessary to perform the procedures, such as the settlement procedures, for each of the actual stores. Therefore, it is possible to eliminate the need to wait for settlement in front of a cash register counter or to wait for the purchased commodities to be packaged.

As shown in FIG. 6B, in the case of shopping at a plurality of affiliated internet stores on the application screen, it is possible to make a collective settlement of the commodities of the affiliated stores at one time. This makes it possible to simplify the settlement processing, and makes it easier to keep track of the purchases.

In the present embodiment, the user A can set a category to the commodities that the user A desires to purchase, and make settlement of a commodity group in each category. Hence, it becomes possible to set a category to each commodity in terms of, for example, a commodity type, a desired delivery condition, the degree of desire for purchase, and the like, and to make settlement of the commodity group in each category at optimum time.

More specifically, when a commodity type category is set to the commodities that the user A desires to purchase and, for example, the commodity group includes a mixture of perishable foods and clothes, it is possible to set different categories to these commodities, and make settlement separately. These commodities can also be delivered separately.

When a commodity delivery condition category is set to the commodities that the user A desires to purchase and, for example, a commodity group that the user desires to purchase includes a commodity that the user desires delivery on the same day and other commodities, different categories can be set to these commodities, and the commodity group that the user desires delivery on the same day can be settled first and delivered.

According to the present embodiment, the information processing device 30 generates display information to display to the user A the commodity group specified in the specification unit 220 as a commodity group scheduled to be settled. The display information includes a cancellation indication object to indicate cancellation of the settlement of the respective commodities that constitute the commodity group. Therefore, after the user A desires to purchase the commodities, the user A can cancel purchase of the commodities displayed as a commodity group scheduled to be settled as necessary. This allows the user A an opportunity to reconsider the purchase of individual commodities after the user A desires to purchase the commodities at stores or on the application.

In the present embodiment, for the commodity group after execution of the settlement processing, purchase information about the respective commodities that constitute the commodity group can be generated, and the purchase information can be notified to the store terminals 40 of the affiliated stores C1 to C2 that are vendors of the commodities. This makes it possible to promptly notify the status of purchase of the commodities of the stores C1 to C3 to the store side, and reflect the status on stock information and customer information.

In the present embodiment, it is possible to request delivery of the commodity group, after execution of the settlement processing, to the delivery company D in units of commodity groups. This allows the user A to purchase the commodities that the user A sees at the affiliated stores C1 to C3 and to go home empty-handed, so that a load of the user A related to shopping can be reduced. Furthermore, since it is possible to collectively deliver the commodities purchased at the affiliated stores C1 to C3 in units of commodity groups, the procedures for the user A to receive the commodities can be simplified.

### Second Embodiment

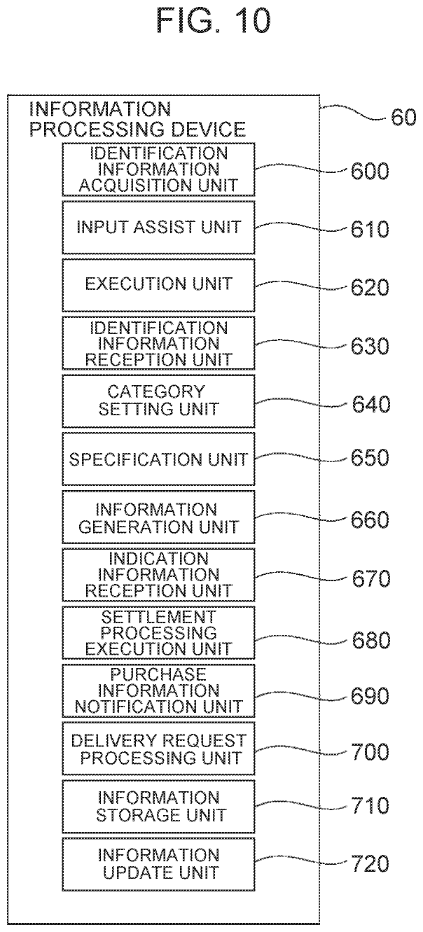

A second embodiment of the present disclosure will be described below with reference to FIG. 10. The component members similar in configuration to those in the first embodiments are designated by similar reference signs to omit the description thereof. In the second embodiment, the processing performed by the information processing device 20 and the information processing device 30 in the first embodiment is carried out by an information processing device 60. Since the hardware configuration of the information processing device 60 is similar to the configuration of the information processing device 30 in the aforementioned first embodiment, the description thereof is omitted.

FIG. 10 is a block diagram showing the functional configuration of the information processing device 60. Each of the functions of the information processing device 60 is implemented when the CPU 31 reads and executes the execution programs stored in the ROM 32. As shown in FIG. 10, the information processing device 60 includes an identification information acquisition unit 600, an input assist unit 610, an execution unit 620, an identification information reception unit 630, a category setting unit 640, a specification unit 650, an information generation unit 660, an indication information reception unit 670, a settlement processing execution unit 680, a purchase information notification unit 690, a delivery request processing unit 700, an information storage unit 710, and an information update unit 720.

The identification information acquisition unit 600, the input assist unit 610, the execution unit 620, the identification information reception unit 630, the category setting unit 640, the specification unit 650, the information generation unit 660, the indication information reception unit 670, the settlement processing execution unit 680, the purchase information notification unit 690, the delivery request processing unit 700, the information storage unit 710, and the information update unit 720 correspond to the identification information acquisition unit 300, the input assist unit 310, the execution unit 320, the identification information reception unit 200, the category setting unit 210, the specification unit 220, the information generation unit 230, the indication information reception unit 240, the settlement processing execution unit 250, the purchase information notification unit 260, the delivery request processing unit 270, the information storage unit 280, and the information update unit 290 stated in the first embodiment, respectively. Since the operation of each unit in the information processing device 60 is similar to the operation of the information processing device 20 and the information processing device 30 described in the first embodiment, the detailed description thereof is omitted.

### Remarks

In the above embodiments, various processing is executed when the CPUs 21, 31 read and execute software (programs). However, the processing may be executed by various processors other than the CPUs. Examples of the processors in this case may include programmable logic devices (PLDs) capable of changing circuit configuration after manufacturing, such as field-programmable gate arrays (FPGAs), and exclusive electrical circuits that are processors having circuit configuration exclusively designed for execution of specific processing, such as application specific integrated circuits (ASICs). Various processing may be executed by one of the various processors, or may be executed by a combination of two or more processors of the same kind or different kinds (for example, a combination of a plurality of FPGAs, a CPU, and an FPGA). More specifically, the hardware structure of the various kinds of processors corresponds to an electrical circuit formed by combining circuit elements, such as semiconductor elements.

In each of the embodiments described in the foregoing, various processing programs are pre-stored (installed) in the ROM or the storage. However, the present disclosure is not limited to this configuration. The programs may be provided in the form of being recorded on recording media, such as compact disc read only memories (CD-ROMs), digital versatile disc read only memories (DVD-ROMs), and universal serial bus (USB) memories. The programs may also take the form of being downloaded from external devices through a network.

The flow of processing described in the aforementioned embodiments is merely illustrative, and therefore it is possible to delete an unnecessary step, to add a new step, or to change the processing order without departing from the meaning of the present disclosure.

What is claimed is:

1. An information processing system comprising an information processing device, the information processing device including:
an identification information reception unit configured to receive identification information that identifies prescribed commodities that a user desires to purchase at a plurality of affiliated stores,
a specification unit configured to specify, based on the received identification information, a commodity group that the user desires to purchase,
an indication information reception unit configured to receive indication information to indicate settlement of the commodity group, and
a settlement processing execution unit configured to execute, when the indication information is received, settlement processing for the commodity group.

2. The information processing system according to claim 1, wherein:
the information processing device further includes a category setting unit configured to set a category to the commodities based on the identification information; and
the specification unit specifies the commodity group in each set category.

3. The information processing system according to claim 2, wherein the category is a commodity type category.

4. The information processing system according to claim 2, wherein the category is a delivery condition category.

5. The information processing system according to claim 1, wherein:
the information processing device further includes an information generation unit configured to generate display information to display to the user the specified commodity group as a commodity group scheduled to be settled; and
the display information includes a cancellation indication object to indicate cancellation of the settlement for the respective commodities that constitute the commodity group.

6. The information processing system according to claim 1, wherein:
the information processing device further includes a purchase information notification unit; and
the purchase information notification unit is configured to generate, for the commodity group after execution of the settlement processing, purchase information about the respective commodities that constitute the commodity group, and
notify the purchase information to store terminals of the affiliated stores that are vendors of the commodities.

7. The information processing system according to claim 1, wherein:
the information processing device further includes a delivery request processing unit; and
the delivery request processing unit is configured to
generate, for the commodity group after execution of the settlement processing, request information to request delivery in units of the commodity group, and
notify the request information to a delivery terminal of a delivery company.

8. A method of information processing, comprising:
receiving identification information that identifies prescribed commodities that a user desires to purchase at a plurality of affiliated stores;
specifying, based on the received identification information, a commodity group that the user desires to purchase;
receiving indication information to indicate settlement of the commodity group; and
executing, when the indication information is received, settlement processing for the commodity group.

9. A program causing a computer to execute:
receiving identification information that identifies prescribed commodities that a user desires to purchase at a plurality of affiliated stores;
specifying, based on the received identification information, a commodity group that the user desires to purchase;
receiving indication information to indicate settlement of the commodity group; and
executing, when the indication information is received, settlement processing for the commodity group.
